(19) United States
(12) Patent Application Publication
(10) Pub. No.: US 2009/0222754 A1
(43) Pub. Date: Sep. 3, 2009

(54) SYSTEM AND METHOD FOR GENERATING INTEGRATED TICKER DISPLAY FOR BROADCAST MEDIA CONTENT

(75) Inventors: Anthony H. Phillips, Southampton (GB); Tim Preece, Eastleigh (GB)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/040,060

(22) Filed: Feb. 29, 2008

(51) Int. Cl. G06F 3/048

(52) U.S. Cl. 715/774

(57) ABSTRACT

A system and method for enabling the recipient of a multi-media broadcast containing a ticker to control the content of the ticker while the broadcaster controls the ticker's appearance. This allows a broadcaster to maintain the program's “look-and-feel” and at the same time provide flexible display content.

### BACKGROUND OF THE INVENTION

1. Field of the Invention

The present invention relates to digital broadcast systems of media content, e.g., video content, and more particularly, to an enhanced system and method for generating a ticker display portion that can be tailored to a local audience and updated with local audience/viewer input.

2. Description of the Prior Art

A ticker, or crawler, is a continuously updated content displayed in conjunction with a broadcast image. For example, news broadcasts generate a ticker display portion, typically at a bottom one-tenth of the presented display dedicated to headline news.

In conventional digital multi-media content broadcasting systems, broadcasters embed or “burn” the ticker into the displayed image at broadcast time. All viewers of the broadcast see the same ticker information. The problem is that the ticker is not localized for the target audience. For example, with reference had to FIG. 1 depicting an example screen capture of a BBC news display, if BBC News 24 is shown in an airport departure lounge it would make sense to display departure gate information in the ticker. In the airport arrival hall, the same BBC News 24 broadcast could display inbound flight information. This concept extends to many target recipients. A company can display their own news and events in the ticker bar on television sets or broadcast display monitors around their premises. A restaurant catering to Spanish-speakers can select a Spanish-language ticker for a CNN broadcast. These are just examples of but a few of the potential applications utilizing a dynamically configurable ticker.

While prior art systems such as TVTicker (http://tvticker.worldflash.com) provides an overlay of a broadcast video signal with Internet sourced news information, the broadcaster has no control of the overlaid ticker. For example, the broadcaster has no control over the appearance (e.g., look and feel) of the ticker. That is, the look and feel comprising, for example, a size, position, font, coloring of the ticker display.

It would be highly desirable to provide a system and method directed at enabling the broadcaster to maintain control over the appearance of a ticker broadcast to multiple user devices, while at the same time permitting the broadcast signal recipient to control the content of the ticker.

### SUMMARY OF THE INVENTION

This invention is directed to a system and method for providing a ticker display field that can be tailored to a local audience implemented in a broadcast system that enables the broadcaster to retain control over the appearance of the ticker.

As part of this system, a receiver device associated with the viewer or recipient is equipped to decode and display dynamic ticker content. The changes allow the receiver to show locally relevant “content” within a ticker display field integrated within an audio/visual broadcast. Only the broadcaster is enabled to control the ticker appearance or “style.” Both the broadcaster and signal recipient both control ticker “content.” Ticker “style” and “content” are delivered in the form of metadata sent in parallel with or embedded within the broadcast audio/video signal.

The “style” metadata allows the receiver device to display the ticker so that it is visibly consistent with the broadcasters normal ticker. This functionality allows the broadcaster to maintain the “look-and-feel” of the ticker, such that the ticker does not look glued on top of the video signal. It also ensures that the ticker content will be visible if the background of the picture is radically different from normal. Thus, in this context, look and feel comprises, but is not limited to: a size, position, font, coloring of the ticker display.

Ticker “content” is delivered or retrieved from multiple sources. The broadcaster may deliver textual content or provide a URL for its retrieval. In addition, users may specify their own URL(s), thus allowing the ticker content to be tailored to a local level. Textual content is not limited to “plain-text” but may include MIME encoded graphics as well.

Thus, advantageously, as part of the system and method, the broadcaster can specify a ticker definition that includes a topic (e.g., sports) that informs the receiver device what category of content the ticker should display. For example, during a sports program the ticker definition would be “sport”. The user receiver device would use this to select appropriate ticker content.

Note that changes are made to the broadcast signal, not the hardware used to send the signal. This is because the metadata is transmitted in parallel with the audio/video signal. Modern broadcast networks already have this capability. For example, most cable and satellite networks already send television guide information to set-top boxes.

Thus, in accordance with one aspect of the invention, thus is provided a system and method for integrating a ticker display on a user's video device, the ticker adapted to be displayed over a video display associated with a broadcast presentation, wherein the method comprises:

providing, by a broadcaster, a data stream comprising metadata for generating one or more ticker displays suitable for presentation on a user device for a user device, said data stream metadata comprising one or more of: ticker-definition values and ticker-content, said ticker-definition values specifying visual attributes for achieving a particular aesthetic look of said one or more ticker displays and optimum placement on a user screen when overlaid with said broadcast presentation;

receiving, by a processing device associated with a user, said data stream;

processing, by said processing device, said data stream to form said ticker to be integrated with said broadcast presentation for display at said user device;

specifying, by a user, a content to be added to said broadcast ticker content or specified by said broadcaster; and,

receiving, by said processing device associated with a user, said user-specified ticker content, and modifying said content of said ticker for display on said user's video device,

wherein said processing device maintains said particular aesthetic view of said ticker according to said ticker definition parameters while providing said user-specified additional content for viewing via said user's video device.

### BRIEF DESCRIPTION OF THE DRAWINGS

Further features, aspects and advantages of the apparatus and methods of the present invention will become better understood with regard to the following description, appended claims, and accompanying drawings where:

FIG. 1 is an example screen shot from a real BBC News 24 broadcast;

FIG. 2 illustrates an example display monitor showing a time ticker and a news headline ticker in accordance with the present invention;

FIG. 3 illustrates the ticker content refresh algorithm implemented in accordance with the present invention; and,

FIG. 4 illustrates an overview of the system components in which the present invention is employed.

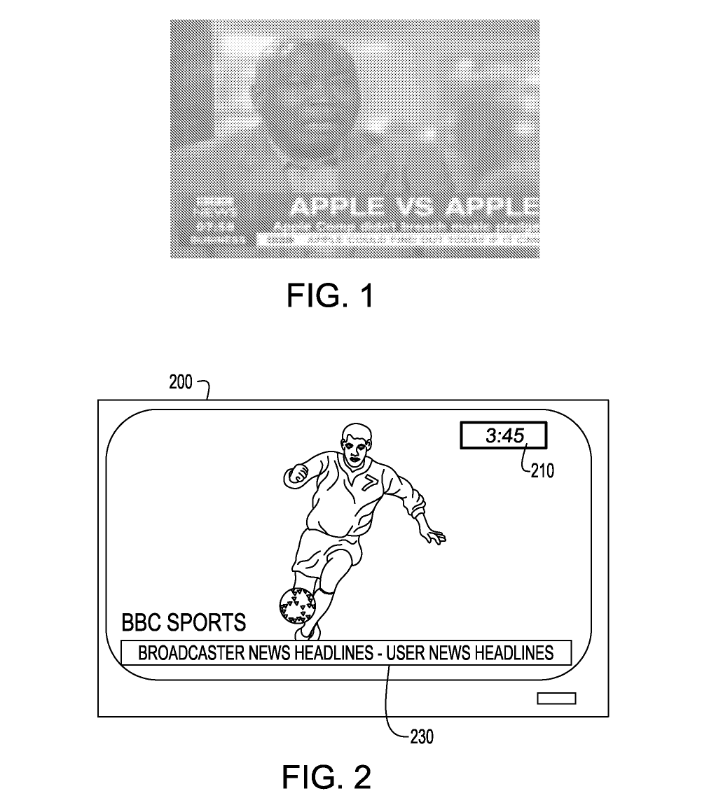

### DETAILED DESCRIPTION OF THE PREFERRED EMBODIMENT

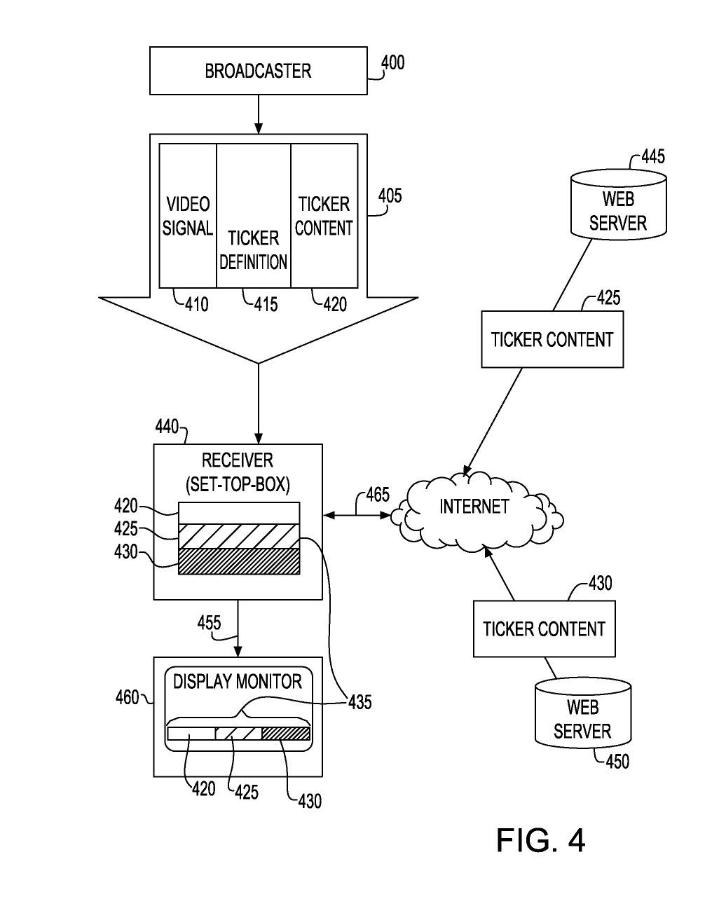

FIG. 4 depicts an example system infrastructure in which the present invention is employed. As shown in FIG. 4, there is illustrated an audio/visual broadcast system includes, a broadcaster 400 who transmits 405 a “ticker-definition” 455 in parallel to, or embedded 405 with, a standard audio/video signal 410 received by a receiver device 440 associated with the viewer or broadcast signal recipient. As known to skilled artisans, the “receiver” device is capable of combining a visual representation of the ticker-definition with a video signal 410 and outputting 455 the combined image to a display monitor 460 such as associated with a user or broadcast recipient. In one non-limiting embodiment, the receiver device 440 is a user Set Top Box (STB) associated with user display monitor which may be separate from or part of a television set or other digital video broadcast receiver, or may be a satellite TV receiver or a processing device such as a computer equipped to receive and process digital broadcast signals. In the manner as will be explained in further detail herein below, the broadcaster 400 is in complete control of the ticker's appearance. The content displayed within the ticker 435 is under the control of both the broadcaster 400 and the broadcast signal recipient. The ticker-definition and ticker-content is broadcast along with the audio/video content in a manner as would be known to skilled artisans. That is, many pre-existing mechanisms exist for doing this such as: MPEG-4 for digital streams, and/or embedding content in the Vertical Blanking Information (VBI) for analog streams, as non-limiting examples.

The receiver device 440 also includes program code for generating a user interface permitting a user to manage URL's associated with a particular content topic. For a particular content topic, a recipient can define a URL and refresh interval. This functionality allows content to be localized to the user.

With more particularity, the elements of the invention illustrated in FIG. 4 comprise: a) a signal with embedded metadata 405 generated by a broadcaster 400; b) the “receiver” device 440, c) an Internet connection 465 established via functionality employed at the receiver device for searching and obtaining web-based content according to a dynamically specified or pre-specified URL, and d) the display monitor 460. As will be explained, the metadata is comprised of a ticker-definition 415 and ticker-content 420. The term “display monitor” is meant to include any device capable of displaying a visual image, for example, a television or a computer monitor. The term “Internet” is meant to encompass the public interact or World-Wide-Web, a private network or “Intranet.” The broadcast signal may be, but is not limited to, delivery through a cable-television system, satellite, radio, or Internet (e.g., IPTV).

The receiver 440 is capable of: a) receiving a signal sent by a broadcaster 405, b) retrieving ticker content via the Internet 465 from a URL, c) sending a signal with combined ticker 435, video, and audio 455 to a user display monitor 460, d) updating ticker content, e) combining content from multiple sources 435; and f) providing a means of allowing a user to input a URL and update-interval associated with a particular TOPIC whereby the receiver initiates the ticker-content update process.

The ticker-definition 455 dictates the appearance, or “look-and-feel” of the ticker 435 and is provided by the broadcaster 400 in the form of a “ticker-definition” record. The content displayed in the ticker 435 is delivered 405 as text and/or as a URL. “Content” in this context means either textual information or textual information retrieved from a URL, but can be other types of content, e.g., symbols, icons, graphics or other types of content suitable for display in the ticker.

According to the invention, in one non-limiting environment, the fields for a TICKER DEFINITION record to be provided by the broadcaster for controlling the look and feel of the ticker that is to be displayed by the receiver are defined in an example embodiment as follows:

| Field | Description |
|---|---|
| TICKER-INDEX | Ticker identifier. |
| POSITION | The position on screen for the news ticker. |
| STATUS | Status indicating whether the ticker is visible or |
| | hidden. |
| STYLE | Appearance of the ticker including: font, font-size |
| | and background color. |
| SCROLL | Speed at which the news should scroll across and |
| | in what direction. |
| RESOLUTION | As an option, a broadcaster can send multiple ticker |
| | definitions one for each type of display resolution. |
| SCENE | When the next scene change will occur. |
| TICKER- | Container for ticker-content record, defined infra. |
| CONTENT | |
| TOPIC | Current program topic |

In one embodiment of the invention a ticker-definition includes a data structure having the following fields to control the visual depiction of a ticker: TICKER-INDEX, POSITION, STATUS, STYLE, SCROLL, RESOLUTION, and SCENE. These fields allow the broadcaster to create a uniform ticker “look-and-feel” irrespective of the content. Controlling “look and feel” comprises, but is not limited to: a size, position, font, and coloring of the ticker display.

More particularly, with reference had to FIG. 2, the TICKER-INDEX field allows multiple tickers 210, 230 to be visible at the same time on the recipients display monitor. The field value differentiates among the concurrently visible tickers. In an example embodiment, TICKER-INDEX #1 refers to a time ticker 210 to be displayed in the upper-right portion of the screen while TICKER-INDEX #2 refers to a headline news 230 ticker for display across the bottom of the screen. The screen size is the only limit to the number of concurrently visible tickers.

The POSITION field value defines the ticker location on the video screen. The precise value will depend on the implementation. A screen may be divided into pre-defined regions, X-Y coordinates, or various other techniques known to those familiar with the art of drawing rectangles. At a minimum, the POSITION field will contain enough information to permit the receiver to overlay a rectangle on the video signal. A simple implementation could include an X coordinate, Y coordinate, width, and height; all encoded into an integer value.

The STATUS field value indicates the visibility of the ticker. This feature permits the broadcaster to control ticker visibility, allowing it to turn off the ticker at the desired moment. This control may be desired when the entire screen needs to be visible, for example, when commercials are playing.

The STYLE field value defines a ticker's visual attributes. At a minimum, the visual attributes are: font, font size, foreground and background colors. This list of attributes is not exhaustive as additional font properties exist and others may develop in the future.

The SCROLL field value controls the speed and direction of the content displayed in the ticker. Speed is determined by the magnitude of the value with “0” indicating no scrolling. Positive values indicate one direction while negative values indicate the other direction. The range of values will depend on the implementation.

The RESOLUTION value field allows the broadcaster to tailor the ticker appearance to the various video resolutions available. For example, the current definition is applicable to high-definition video.

The SCENE field includes synchronization information such as: time before the next scene, time before the next program, time before the next content change. This allows the receiver to avoid starting a news highlight just before the television channel switches away. For example, when the broadcast switches to the weather report where the ticker is not visible.

The TOPIC field indicates the present broadcast subject matter. This allows the receiver to display ticker content relevant to current broadcast topic. For example, if BBC News 24 cuts to the daily sports news then the receiver device could display the content source associated with the “sports” topic as specified by the user. In this case, results for local sports teams. The user could further limit the results to a particular sport such as “tennis” by associating “sports” to a local tennis content feed URL. In a further example, as part of the system and method of the invention, the broadcaster can specify a ticker definition that includes a topic (e.g., sports) that informs the receiver device what category of content the ticker should display. For example, during a sports program the ticker definition would be “sport”. The user receiver device would use this to select appropriate ticker content.

Example categorization schemes for TOPIC may include: World News, National News, Local News, Business, Health, Education, Politics, Science/Nature, Technology, Entertainment, or Sports.

An example pseudocode description of a TICKER DEFINITION record is as follows:

```
<ticker-definition> ::= <ticker-index> <topic> <status> [<position>]
        [<style>] [<scroll>] [<ticker-content>]
<ticker-index> :: = integer
<position> ::= <upper-left>, <lower-right>
<upper-left> ::= integer, integer
<lower-left> ::= integer, integer
<status> ::= “0” | “1”
<style> ::= <font-name>, <font-size>, <font-color>, <font-highlight>
<font-size>::= integer
<font-color>::= color
<font-highlight>::= color
<scroll> ::= “0” | [“-“] , natural number
<topic> ::= (“world news” | “national news” | “local news” | “business” |
        “health”| “education” | “politics” | “science/nature” |
        “technology” | “entertainment” | “sports”) | {new topic}
<ticker-content> ::= <ticker-content> | <ticker-content-list
```

The TICKER-CONTENT field contains a ticker-content record and is described in more detail below.

Referring back to FIG. 4, “ticker-content” is the information 420 to be displayed in a ticker 435. In one embodiment, there are at least three content sources for display within a particular ticker: 1) textual content from the broadcaster 400, 2) a URL from the broadcaster 425, and 3) a URL defined by the user 430. Ticker-content may be included with the ticker-definition 415 or may be delivered separately 420. Broadcaster supplied ticker-content 420 and ticker-definitions 415 are delivered in the same manner 405. The fields for a “ticker-content” record are defined in an example embodiment as follows:

| Field | Description |
|---|---|
| TICKER-INDEX | Ticker identifier |
| CONTENT | Text or URL content source for display in the ticker |
| UPDATE | If content is a URL, time interval between refreshes. |

The TICKER-INDEX identifies the particular ticker to which the content is directed. This allows content changes that only affect one of multiple tickers visible on the screen. For example, in FIG. 2 content in a ticker displaying the time 210 will need much more frequent updating than a headline news ticker 230.

The CONTENT field includes the ticker content which could be anything, e.g., text or a URL. Where a URL is specified, content must be retrieved from the location specified by the URL. For example, if the user programs or setup a location “snowsports.com” as a content source for the sports category, then the Receiver device would use this hint to go and retrieve content from this URL. In this scenario, the ticker content would typically be retrieved by issuing one or more HTTP requests to the appropriate URL(s) and the payload in the reply could be XML, plain text or something more sophisticated like an ATOM/RSS feed.

The CONTENT field is not limited to a single entry and may contain plurality of textual entries as well as URLs. This allows for the delivery of multiple content streams to a particular ticker. For example, in FIG. 4, a broadcaster may send textual content and two URLs for simultaneous display within the same ticker 435. Where there are multiple content sources for a particular ticker, a content-display list will be required. Each entry in content-display list will be displayed within the associated ticker. A simple algorithm for this is simply to take all the ticker-content list entries and display them one after another 420, 425, 430.

The UPDATE field specifies the time interval until the next request for fresh content from the URL source. This only applies to URLs since the broadcaster updates textual content by sending a new ticker-content record.

An example pseudocode description of a TICKER CONTENT field is as follows:

<ticker-content>::= <ticker-index> <content>
<content>::= {text | <URL-content>}
<URL-content>::= URL, <update-interval>
<update-interval>::= implementation specific value representing time

An example pseudocode description of a collection or list of TICKER CONTENT records is as follows:

<ticker-content-list>::=<ticker-content> | <ticker-content>
{<ticker-content>}

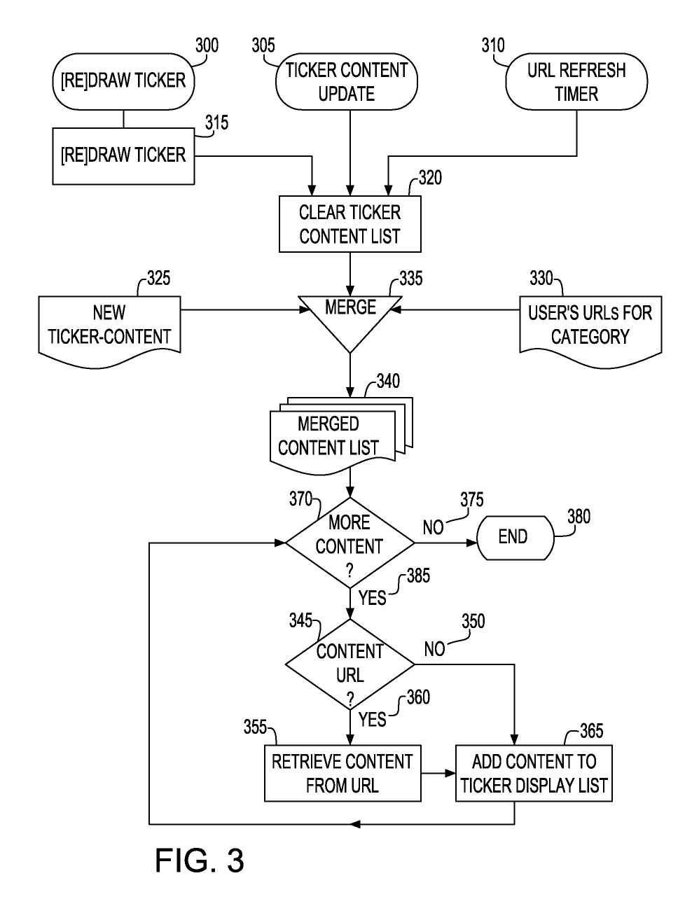

The following example, depicted in FIG. 3, illustrates the retrieval and update functionality of the receiver. The example embodiment is for the purposes of understanding the invention—and is not so limited.

According to this example embodiment, three events trigger the user receiver's ticker update operation. The first event “new ticker-definition” indicated at step 300 occurs upon the receipt of a ticker-definition record. The broadcaster will transmit a ticker-definition to: create a new ticker, hide or unhide an existing ticker, change an existing ticker's appearance, change an existing ticker's position, or to change the current broadcast topic. The new ticker-definition event causes the ticker to which it is directed to be drawn or re-drawn as indicated at step 315.

The second event “ticker-content update” indicated at step 305 occurs upon the receipt of a ticker-content record. The broadcaster will transmit a ticker-content record when the currently displayed non-URL sourced content needs to be updated.

The third event “URL Refresh Timer” indicated at step 310 occurs when the refresh interval for a particular URL whose content is currently being displayed on the ticker expires.

The “URL Refresh Timer” 310 event is raised independently by the user's receiver device 440.

The “ticker-content list” indicated at step 320 is cleared immediately after the ticker has been re-drawn 315, or when the “ticker content-update” 305 or “URL Refresh timer” 310 events have been raised.

The new ticker-content indicated at step 325 is transmitted directly or as part of the TICKER-CONTENT field of the ticker-definition. As indicated at step 335, an operation is performed to merge a list containing the new ticker-content 325 with the user-defined URL for the current TOPIC 330 which forms a merged content list 340. At this point, the merged content list 340 includes a combination of textual content and content specified by the URLs. If the new ticker definition STATUS field indicates the ticker is no longer visible the merge operation 335 will result in an empty merged content list 340. Each entry in the merged content list 340 must be processed. For each item in the merged content list 340: if the item is a URL 350 the content is retrieved 355 and added to the ticker-content-list 365, otherwise 360 the content is added 365 “as is.” When each item in the merged content list has been processed as indicated at step 375, the update procedure is complete 380 and the receiver begins displaying the tickers with the updated information.

Although the embodiments of the present invention have been described in detail, it should be understood that various changes and substitutions can be made therein without departing from the spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded into a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus, the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

What is claimed is:

1. A method for integrating ticker display on a user's video device, said ticker adapted to be displayed over a video display associated with a broadcast presentation, said method comprising:
providing, by a broadcaster, a data stream comprising metadata for generating one or more ticker displays suitable for presentation on a user display device, said data stream metadata comprising one or more of: ticker-definition values and ticker-content, said ticker-definition values specifying visual attributes for achieving a particular aesthetic look of said one or more ticker displays and specifying optimum placement on a user screen when overlaid with said broadcast presentation;
receiving, by a processing device associated with said user display device, said data stream;
processing, by said processing device, said data stream to form said ticker to be integrated with said broadcast presentation for display at said user display device;
specifying, by a user, a content to be added to said broadcast ticker content; and,
receiving, by said processing device associated with a user, said user-specified ticker content, and modifying said content of said ticker for display on said user's video device,
wherein said processing device maintains said particular aesthetic view of said ticker according to said ticker definition parameters while displaying user-specified added content for said ticker via said user's display device.

2. The method according to claim 1, wherein said datastream includes metadata specifying one or more ticker definition parameters including fields comprising one or more of: a TICKER-INDEX field for identifying a specific ticker; a POSITION field for identifying the ticker position on a display monitor; a STATUS field for indicating the whether the ticker is visible or hidden; a STYLE field for indicating one or more a font, font color, a background color within said ticker; a SCROLL field indicating the speed and direction ticker content is displayed; and, TICKER-CONTENT field containing content to be displayed within a ticker.

3. The method according to claim 1, wherein said datastream includes metadata specifying one or more ticker definition parameters including fields comprising one or more of: a TICKER-CONTENT field for specifying ticker-content; a TOPIC field for specifying a broadcast topic.

4. The method according to claim 3, wherein said user specified content includes content associated with a user-specified URL, said processing device initiating a web-based search for said URL content and retrieving said content for updating said ticker display.

5. The method according to claim 3, further comprising controlling, by said broadcaster, said ticker definition values so that said ticker dynamically changes visual attributes as a broadcast presentation changes.

6. The method according to claim 3, further comprising: merging said ticker content from a user specified URL with content of said broadcaster ticker content.

7. A receiver device associated with a user display device for displaying a broadcast presentation with a ticker field, said receiver device comprising:
means for receiving an audio/video broadcast signal associated with said broadcast presentation, said means further receiving a data stream comprising metadata for generating a ticker display suitable for presentation on a user display device, said data stream metadata comprising one or more of: ticker-definition values and ticker-content, said ticker-definition values specifying visual attributes for achieving a particular aesthetic look of said ticker display and specifying optimum placement on a user screen when overlaid with said broadcast presentation;
processing device for processing said data stream to form said ticker to be integrated with said broadcast presentation for display at said user display device;
means for specifying, by a user, a content to be added to said broadcast ticker for display, said processing device receiving said user-specified ticker content, and updating said content of said ticker with said user-specified ticker content for display on said user's video device,
wherein said processing device maintains said particular aesthetic view of said displayed ticker according to said ticker definition parameters while causing display of said user-specified added content for said ticker via said user's display device.

8. The system as claimed in claim 7, wherein said processing device for processing said data stream to form said ticker further comprises:
interface means for enabling user specification of ticker content associated with a specified URL;
means for retrieving said user-specified ticker content from the location specified by said URL and generating a new ticker-content record with new user-specified ticker content; and,
means for merging current delivered content with new user-specified ticker content included with said new ticker-content record.

9. The system as claimed in claim 7, further comprising:
means for updating said ticker content at one of: a time an update interval expires, or when a current scene of said broadcast presentation changes.
